(19) United States
(12) Patent Application Publication
(10) Pub. No.: US 2003/0200873 A1
(43) Pub. Date: Oct. 30, 2003

(54) Vortex cheese processing apparatus and method

(76) Inventor: Joseph Abler, Brookfield, WI (US)

Correspondence Address: QUARLES & BRADY LLP, 411 E. WISCONSIN AVENUE, SUITE 2040, MILWAUKEE, WI, 53202-4497, US

(21) Appl. No.: 10/131,378

(22) Filed: Apr. 24, 2002

(51) Int. Cl. A23C 1/00

(52) U.S. Cl. 99/452; 99/516

(57) ABSTRACT

A cheese cooker and mixer includes a tank containing heated water. The tank has an outer cylindrical housing with an concentric inner cylindrical screen. An inlet proximate to a top of the tank provides an opening by which cheese curds are introduced within the cylindrical screen. The heated water is fed into the tank tangentially to the curvature of the cylindrical screen to create a vortex therein which aids in directing the cheese downward in the tank. After melting and forming a large mass, the cheese is extracted through an outlet proximate to a bottom of the tank. A conveyor with counter rotating augers mixes the cheese exiting the tank.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to cheese processing equipment; and more particularly to equipment which cooks and mixes the cheese prior to molding or extrusion.

2. Description of the Related Art

Mozzarella cheese is processed by dropping curds into a tank of hot water in which the cheese cooks. This causes the curds to melt and sink to the bottom of the tank where a large mass of relatively soft cheese forms. One or more augers at the bottom moves the cheese out of the tank and up an inclined enclosure. The augers stretch and mix the softened cheese into a homogeneous mass at a relatively uniform temperature. That homogeneous cheese mass then is expelled through an outlet into an extruder or a molding machine. U.S. Pat. No. 5,988,052 describes this type of cheese processing equipment.

The water in the tank is maintained at the proper cooking temperature (e.g. 77° C.) by circulation through an external heater. Specifically, water leaves the tank through a drain at the bottom of the tank A pump draws the water from the drain and forces the liquid through a heater in which electricity or steam is used to raise the temperature of the water. The heated water then is returned to the top of the tank completing the circulation cycle.

The capacity of a given cooker/mixer is determined by how much cheese can be dropped into the tank before unmelted cheese enters the output conveyor. When this occurs the cheese expelled from the auger assembly will not be fully heated and will not be properly stretched.

The through put of the processing equipment also is adversely affected by stagnant water which allows clumps of cheese to matt, thereby inhibiting proper melting as the cheese descends in the tank. This allows cheese curds to float in the liquid, as the curd are too buoyant to be pressed into the augers. The tendency of the curds to float is increased when a brine solution is used in the tank to add salt to the cheese. As a consequence, the cheese maker previously had to monitor the tank and use a shovel or other implement to push the floating cheese curds downward into the augers.

Thus there still exits a need for a more automated cheese cooker/mixer.

### SUMMARY OF THE INVENTION

A cheese processing apparatus has a tank for containing a liquid, such as water, that is heated to a temperature which will soften or melt cheese placed into the tank. An inlet proximate to a top of the tank is provided in order to introduce the cheese into the liquid and an outlet proximate to a bottom of the tank enables the softened cheese to be removed. A mechanism is included to create a vortex of the liquid within the tank. The rotating action of the vortex aids in directing the cheese toward the center of the tank as the cheese descends in the tank. In addition, the swirling liquid prevents the cheese from sticking to the walls of the tank.

In a preferred embodiment of the cheese processing apparatus, the tank has a cylindrical inner wall formed by a screen and within which the vortex is created. The liquid is fed into the tank through a supply conduit that has an outlet aperture from which the liquid flows into the tank in a direction that produces the vortex. For example, the liquid is directed substantially tangential to the curvature of the cylindrical inner wall. A portion of the liquid flows outward through the screen of the inner wall and is exhausted via a drain opening in the tank. The liquid exhausted from the tank preferably is recycled by a pump to the supply conduit.

Another aspect of the present invention is the provision of a conveyor that carries the processed cheese from the outlet of the tank. Preferably the conveyor is an auger type which mixes the cheese being conveyed.

### BRIEF DESCRIPTION OF THE DRAWINGS

FIG. 1 is a side view of a cheese cooker/mixer according to the present invention;

FIG. 2 is a top view of the tank on the cheese cooker/mixer, and

FIG. 3 is a cross sectional view through the tank along line 3-3 in FIG. 2.

### DETAILED DESCRIPTION OF THE INVENTION

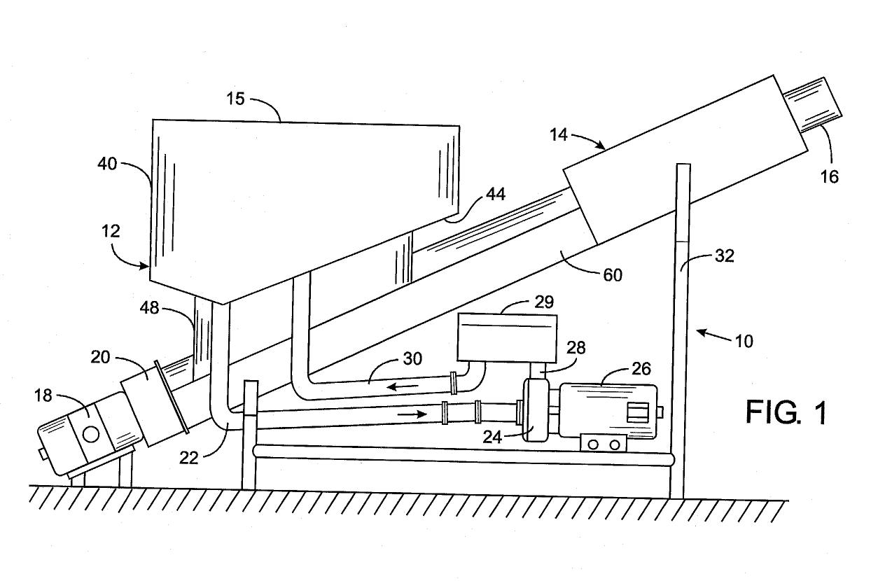

With initial reference to FIG. 1, a cheese processing apparatus 10, such as cooker/mixer, has a circular cylindrical tank 12 which is mounted on an inclined mixing conveyer 14. A frame 32 supports these and other components of the cooker/mixer 10. The tank 12 has an open top serving as an inlet 15 through which cheese curds are received. As will be described, the tank is filled with hot water through which the cheese curds sink into an outlet at the bottom of the tank. The tank outlet is connected to the mixer/conveyer 14 driven by a first electric motor 10 and a gear transmission 20. The melted cheese flows through the outlet and is transported up the inclined mixer/conveyer 14 from which the cheese is expelled through an outlet tube 16 at the top of the incline. As will be understood by those skilled in the art, the stream of cheese flows from the outlet tube 16 will into an extruder or molder depending upon the particular cheese manufacturing process.

A pair of drain pipes 22 extend from openings on opposite sides of the tank to a pump 24 that is driven by a second electric motor 26. An outlet connection 28 of the pump 24 is connected to the conventional heater 29 which raises the temperature of the water to the desired temperature (e.g. 77° C.). Two inlet pipes 30 on opposite sides of the tank 12 receive water from the heater 29 and emit that liquid into the tank 12, as will be described.

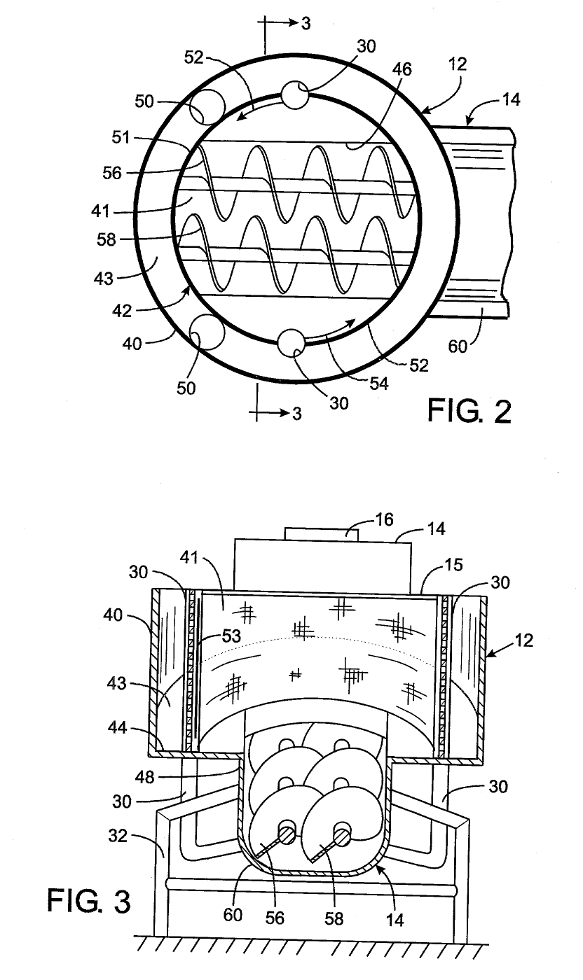

With the reference to FIGS. 2 and 3, the tank 12 comprises a cylindrical outer wall 40 with a concentric, cylindrical inner wall 42 which divides the tank into a central inner region 41 and a surrounding outer region 43. The outer wall may be rectangular or other geometric shapes, and as a further alternative the outer region 43 may extend only partially around the inner region 41. The inner wall 42 is formed by a screen which has a plurality of apertures there through which are small enough so that the curds and other typical sized particles of cheese cannot pass through while allowing water to fully flow through the inner wall. The material of the screen may comprise a two dimensional array of interwoven wires, hardware cloth, expanded metal, a metal sheet with apertures, or equivalent material that forms a suitable mesh pattern. However, the inner wall 42 is not required to have a two dimensional array of apertures, as long as there are a sufficient number of apertures to allow an adequate flow of water there through. Both the outer and inner walls 40 and 42, as well as other metal components of the cheese processing apparatus 10, are preferably formed of stainless steel.

An inclined bottom wall 44, that matches the incline of the mixer/conveyor 14, extends abuts the lower edges of the outer and inner walls 40 and 42 (see also FIG. 1). The section of the bottom wall 44 within the inner wall 42 has an opening into a lower section 48 of the tank 12. That lower section 48 couples inner region 41 of the tank to an outlet 46 into the mixer/conveyor 14 and provides a passageway for cheese to descend into the mixer/conveyor.

With reference to all three Figures, a pair of drain openings 50 are located in the outer region 43 of the tank through the bottom wall 44 and connect to the drain pipes 22. The water inlet pipes 30 extend upward through the bottom wall 44 and vertically through the interior of the tank 12. In the preferred embodiment shown in FIG. 2, the inner wall 42 is formed by two nearly semi-cylindrical sections 51 and 52 each extending between the two inlet pipes 30 on opposite sides within the outer housing. The section of each of the inlet pipes 30 within the inner wall 42 has a vertical outlet slot 53 (as seen FIG. 3) which runs substantially the full height of that inner wall. The outlet slot 53 is oriented to emit a stream of water substantially tangential to the interior curved surface of the inner wall 42, as denoted by arrows 54 in FIG. 2. As will be described in greater detail, this emission of water from the inlet pipes 30 creates a vortex within the tank 12 which forces the cheese curds inward and downward within the tank and into the mixer/conveyer 14. It should be understood that the stream of water upon exiting the inlet pipe 30 does not have to be precisely tangential to the curved inner wall, as long as the direction of that water stream is substantially tangential so as to create the vortex within which the cheese moves. Alternatively, instead of a single outlet slot 53, each inlet pipe 30 may have a series of apertures or nozzles which produce a plurality of water jets that create the vortex.

Although the preferred embodiment of the present invention generates the vortex by selectively directing the flow of water into the tank and thus does not employ any additional moving parts for that purpose, other mechanisms may be employer to create the vortex. For example, a rotating agitator driven mechanically or magnetically by another motor could produce the swirling motion of the water in the tank.

With continuing reference to FIGS. 2 and 3, the mixer/conveyer 14 has a pair of augers 56 and 58 extending longitudinally at an upward angle within a casing 60. The augers 56 and 58 are slightly intermeshed so that when rotating the mass of melted cheese which enters from the tank 12 is driven upward to the outlet tube 16. The first electric motor 18 and transmission gear box 20 (FIG. 1) at the lower end of the mixer/conveyer 14 counter rotates the two augers 56 and 58.

Prior to operation of the cheese cooker/mixer 10, the tank 12 is filled with water that has been heated to the desired temperature (e.g. 77° C.). The pump 24 draws water from the tank through the drain openings 50 and the outlet pipes 22. This water is then forced through the heater 29 and returns via the inlet pipes 30 on each side of the tank 12. The water enters tangentially to the curvature of the inner wall 42 in the tank 12 and causes the hot water to swirl therein creating a vortex. When cheese curds are dropped into the inner region 41 through the open top of the tank 12, the swirling water generates a vortex which draws the curds downward to the center of the tank and into the pair of augers 56 and 58. This prevents the cheese from adhering to the lower surfaces of the tank and thus not entering the mixing conveyer 14. The swirling water in the upper portion of the tank 12 moves the curds away from the inner wall 42 thereby providing a self-cleaning effect should any cheese become lodged in an screen opening. This vortex action also separates the individual curds to more rapidly heat each curd while descending through the vortex to the augers 56 and 58. This further ensures that as melted cheese accumulates in the lower portion of the tank, that accumulated large mass of cheese continues to move downward into the mixer/conveyer 14 where the augers force the mass upward toward the outlet tube 16.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. An cheese processing apparatus comprising:
a tank for containing a liquid at a temperature which causes the cheese to melt, and having an inlet proximate to a top of the tank through which to introduce the cheese and an outlet proximate to a bottom of the tank through which to remove melted cheese; and
a mechanism to create a vortex of the liquid within the tank.

2. The cheese processing apparatus recited in claim 1 wherein the mechanism to create a vortex comprises a conduit for carrying the liquid and having at least one aperture that opens into the tank, wherein liquid flowing through the aperture produces a vortex in the tank.

3. The cheese processing apparatus as recited in claim 1 wherein the tank comprises outer wall and an cylindrical wall within the outer wall and having plurality of apertures there through, wherein the inlet and outlet communicate within the cylindrical wall.

4. The cheese processing apparatus as recited in claim 1 wherein the tank comprises an interior wall having plurality of apertures there through and dividing the tank into a first region and a second region, wherein the inlet and outlet communicate with the first region.

5. The cheese processing apparatus as recited in claim 4 wherein the second region extends around the first region.

6. The cheese processing apparatus as recited in claim 4 wherein at least a portion of the interior wall is formed by a screen.

7. The cheese processing apparatus as recited in claim 4 wherein mechanism creates the vortex within the first region.

8. The cheese processing apparatus as recited in claim 4 wherein the interior wall is curved and the mechanism to create a vortex comprises a conduit for carrying the liquid and having at least one aperture through which emerges a flow of the liquid which is directed substantially tangential to the interior wall

9. The cheese processing apparatus as recited in claim 4 wherein the tank further comprises a drain opening which receives the liquid from the second region.

10. The cheese processing apparatus as recited in claim 1 further comprising a conveyor adjacent the outlet to receive the cheese removed from the tank.

11 The cheese processing apparatus as recited in claim 10 wherein the conveyor comprises an auger within a casing that is inclined upward from the outlet of the tank and which has an opening in upper section through which the auger ejects the cheese.

12. A cheese processing apparatus comprising:
a tank for containing a liquid and having an outer housing and a cylindrical interior wall with a plurality of apertures there through, the interior wall dividing the tank into an inner region and an outer region, the tank also having an inlet through which to introduce the cheese into the inner region and having an outlet below the inlet through which to remove the cheese from the inner region;
a first conduit having at least one opening through which the liquid enters the tank and creates a vortex within the inner region; and
a conveyor adjacent the outlet to receive the cheese removed from the tank.

13. The cheese processing apparatus as recited in claim 12 wherein the tank further comprises a drain opening located in the outer region.

14. The cheese processing apparatus as recited in claim 12 wherein the conveyor comprises an auger within a casing that is inclined upward from the outlet of the tank and the casing having an aperture in an upper end through which the auger ejects the cheese.

15. The cheese processing apparatus as recited in claim 12 wherein at least a portion of the interior wall is formed by a curved screen.

16. A method for processing cheese comprising:
delivering a quantity of a heated liquid into a tank;
creating a vortex in the heated liquid contained in the tank;
feeding cheese through an inlet into the tank; and
removing the cheese through an outlet that is below the inlet in the tank.

17. The method for processing cheese as recited in claim 16 wherein creating a vortex comprises introducing additional heated liquid into the tank in a direction which causes the heated liquid to swirl in the tank.

18. The method for processing cheese as recited in claim 16 wherein the tank has a curved wall; and creating a vortex comprises introducing heated liquid into the tank at a direction which is substantially tangential to the curved wall.

19. The method for processing cheese as recited in claim 18 wherein the curved wall has a plurality of apertures there through and is surrounded by an outer wall; and further comprising extracting a portion of the heated liquid through the plurality of apertures and exhausting that portion of the heated liquid through a drain opening in the outer wall.

20. The method for processing cheese as recited in claim 16 further comprising mixing the cheese after being removed through an outlet.
